(19) United States
(12) Patent Application Publication
(10) Pub. No.: US 2022/0317691 A1
(43) Pub. Date: Oct. 6, 2022

(54) SYSTEMS, METHODS, AND APPARATUSES FOR AUTOMATED CROP MONITORING

(71) Applicant: Ladybug Robotics Inc., Vancouver (CA)

(72) Inventor: Hani Eskandari, Vancouver (CA)

(21) Appl. No.: 17/711,994

(22) Filed: Apr. 1, 2022

Related U.S. Application Data
(60) Provisional application No. 63/170,161, filed on Apr. 2, 2021.

(51) Int. Cl. G05D 1/02; G05D 1/00; B60L 53/36; B60L 58/12

(52) U.S. Cl. CPC G05D 1/0217; G05D 1/0231; G05D 1/0038; G05D 1/0291; G05D 1/0044; B60L 53/36; B60L 58/12; G05D 1/0221; G05D 2201/0201

(57) ABSTRACT

A crop monitoring system may include an observation robot, a centralized server, and a user device. An observation robot may be autonomous. The observation robot may include a suite of sensors. The observation robot may include two cameras oriented towards opposite sides of the observation robot to capture images of plants on either side of the observation robot. The centralized server may store and/or execute various instructions for operating and/or communicating with the observation robot. The centralized server may store and/or execute various instructions for processing data such as images, sensor measurements, and environmental data obtained from the observation robot. The centralized server may store and/or execute various instructions for analyzing such data. The centralized server may store and/or execute various instructions for presenting the data to a user, such as via the user device.

### CROSS-REFERENCE TO RELATED APPLICATIONS

The application claims the benefit under 35 U.S.C. § 119(e) to a U.S. provisional application having Application No. 63/170,161, filed Apr. 2, 2021, the entirety of which is herein incorporated by reference.

### BACKGROUND

Agriculture is a labor-intensive industry. In the subclass of agriculture directed to farming, thousands of worker hours are required each season to till fields, plant crops, monitor growth, and harvest. Because crop work is seasonal in many regions, particularly those that experience long, cold winters, labor displacement results in high seasonal turnover. Additionally, as worker skills in the market shift more towards the service and technology industries, it has become increasingly challenging to find a sufficient amount of labor with the right skills to satisfy the demands of farming. Even when sufficient labor is available, data collection and management is challenging. Crop yield may depend on a variety of factors, some of which are not readily apparent from environmental conditions. Where farmers rely heavily on predicting crop yield to determine the profitability of a farm and secure capital, the dearth of available data has led to considerable friction and unpredictability in the market.

### SUMMARY

In one aspect of the present invention, a crop monitoring system is provided and may include an observation robot, a centralized server, and a user device. The observation robot may be autonomous. The observation robot may include a suite of sensors. The observation robot may include two cameras oriented towards opposite sides of the observation robot to capture images of plants on either side of the observation robot. The centralized server may store and/or execute various instructions for operating and/or communicating with the observation robot. The centralized server may store and/or execute various instructions for processing data such as images, sensor measurements, and environmental data obtained from the observation robot. The centralized server may store and/or execute various instructions for analyzing such data. The centralized server may store and/or execute various instructions for presenting the data to a user, such as via the user device

In another aspect of the present invention, a system is provided. The system includes a plurality of robots. The plurality of robots includes at least first and second robots. The first robot is configured to navigate an agricultural field. The first robot is configured to traverse a first avenue adjacent to a first crop row. The first robot collects first data along at least a first side of the first crop row. The second robot is configured to navigate the agricultural field. The second robot is configured to traverse a second avenue adjacent to a second crop row. The second robot collects second data along at least a second side of the second crop row. The first and second avenues traversed by the robots are pre-determined. The first and second data are geotagged. The system includes a storage module configured to store the first and second data collected by the first and second robots. The system includes a data processing module configured to process the first and second data collected by the first and second robots. The system also includes a display configured to display at a user device, the processed data generated by the data processing module.

Other aspects of the disclosed invention will become apparent from the following detailed description, the accompanying drawings and the appended claims.

### BRIEF DESCRIPTION OF THE DRAWINGS

The present description will be understood more fully when viewed in conjunction with the accompanying drawings of various examples of systems, methods, and apparatuses for crop monitoring. The description is not meant to limit the systems, methods, and apparatuses for crop monitoring to the specific examples. Rather, the specific examples depicted and described are provided for explanation and understanding of systems, methods, and apparatuses for crop monitoring. Throughout the description the drawings may be referred to as drawings, figures, and/or FIGs.

FIG. 1 illustrates a crop management system, according to an embodiment.

FIG. 2 illustrates a device schematic for various devices used in the crop management system, according to an embodiment.

FIG. 3 illustrates an observation robot navigating rows of crops, according to an embodiment.

FIG. 4 illustrates an example navigation plan for a set of the observation robots, according to an embodiment.

FIG. 5 illustrates a method of training a machine learning model, according to an embodiment.

FIG. 6 illustrates a method of collecting and analyzing crop data, according to an embodiment.

### DETAILED DESCRIPTION

Systems, methods, and apparatuses for crop monitoring as disclosed herein will become better understood through a review of the following detailed description in conjunction with the figures. The detailed description and figures provide merely examples of the various embodiments of systems, methods, and apparatuses for crop monitoring. Many variations are contemplated for different applications and design considerations; however, for the sake of brevity and clarity, all the contemplated variations may not be individually described in the following detailed description. Those skilled in the art will understand how the disclosed examples may be varied, modified, and altered and not depart in substance from the scope of the examples described herein.

Conventional farming may involve using machinery that acts semi-autonomously under human supervision and/or machinery that operates under direct human control to perform a task in a field. For example, various machines may perform seeding, harvesting, and/or pest control. Large farms with row crops may employ workers to frequently scout the crops, such as to identify issues with the health of the crops, forecast the yield of the season, or identify whether a particular area of the farm should be weeded. Once such observations are made, the evidence is presented to farmers or staff with more experience or knowledge to determine follow-on courses of action.

With the shortage of labor in agriculture, farmers often fall behind in getting the latest status of their fields. Additionally, where human observation is used, such systems are susceptible to human error. For example, a worker may fail to recognize a pest in a crop or a crop disease such as fungal growth. This is a particular risk when inexperienced workers are used due to difficulties in finding sufficiently experienced workers. Even experienced workers may make such mistakes. There may be difficulties in communicating crop issues. In some cases, a crop issue may not be properly recorded, which may result in the crop issue going unaddressed. When crop issues are left unaddressed, they can significantly affect crop yield.

Implementations of systems, methods, and apparatuses for crop monitoring may address some or all of the problems described above. A crop monitoring system may include a set of observation robots, a communication network, a centralized server, and a user device. An observation robot may be autonomous. The observation robot may include a suite of sensors. For example, the observation robot may include a visual light camera, a time of flight (TOF) camera, a depth camera, a lidar, an ultrasound sensor, a radar, a thermal camera, an inertial measurement unit, a global positioning system (GPS), a carbon dioxide (CO2) sensor, an oxygen sensor, a barometer, a temperature sensor, a microphone, and so forth. The observation robot may include two cameras that generate a stereo image. The observation robot may include two cameras oriented towards opposite sides of the observation robot. The two cameras may be oriented to observe rows of crops on either side of the observation robot. The observation robot may include a camera that faces below the observation robot. The observation robot may include a camera that faces above the observation robot.

The centralized server may store and/or execute various instructions for operating and/or communicating with the observation robot. The centralized server may store and/or execute various instructions for processing data such as images, sensor measurements, and environmental data obtained from the observation robot. The centralized server may store and/or execute various instructions for analyzing such data. The centralized server may store and/or execute various instructions for presenting the data to a user, such as via the user device. In various implementations, the user device may include a native application for presenting a graphical or otherwise visual representation of the data. In various other implementations, the centralized server may store and/or execute instructions associated with an application for presenting the data via, for example, a web browser.

The systems, methods, and apparatuses for crop monitoring described herein may reduce and/or eliminate various frictions associated with farm labor. For example, where workers may be fallible in identifying issues with crops such as pests and disease, the systems may enable thorough data collection and/or analysis. The systems may enable more precise identification and recordation of locations in a field where there are issues. The observation robots may obtain other information not readily measurable by workers and may have a perspective on the crops not available to workers. This, in turn, may enable farmers to identify and address crop issues earlier and more consistently. Additionally, the systems may enable more accurate prediction of crop yield and/or fruit quality. The systems may enable more thorough and accurate analysis of historical data to improve crop yield and/or fruit quality. The systems may minimize and/or eliminate the learning curve associated with new workers. The systems may reduce the amount of time it takes to survey a field. The systems may more efficiently survey crops, conserving time and/or resources.

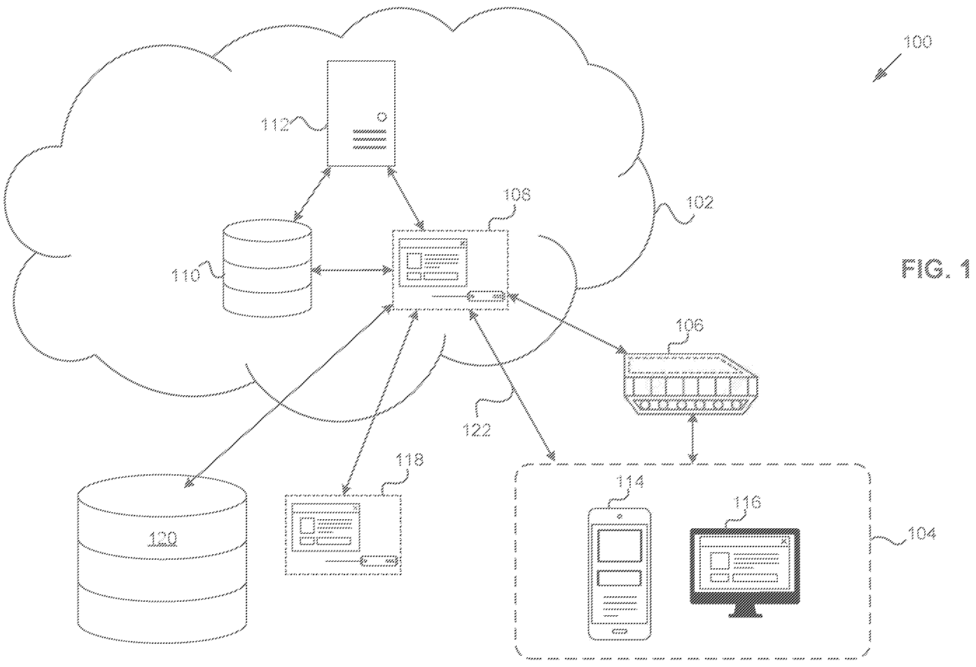

FIG. 1 illustrates a crop management system 100, according to an embodiment. The crop management system 100 includes internal and external data resources for managing a project. The crop management system 100 may result in reduced memory allocation at client devices and may conserve memory resources for application servers.

The crop management system 100 may include a data management system 102, a user device 104, and/or an observation robot 106. The data management system 102 may include an application server 108, a database 110, and/or a data server 112. The user device 104 may include one or more devices associated with user profiles of the crop management system 100, such as a smartphone 114 and/or a personal computer 116. The crop management system 100 may include external resources such as an external application server 118 and/or an external database 120. The various elements of the crop management system 100 may communicate via various communication links 122. An external resource may generally be considered a data resource owned and/or operated by an entity other than an entity that utilizes the data management system 102, the user device 104, and/or the observation robot 106.

The data management system 102 may be cloud-based. For example, the data management system 102 may utilize one or more servers of a server farm that hosts applications for multiple independent customers. The data management system 102 may be cloud-based in that the data management system 102 is accessible by an authorized device from any location with Internet or other remote data access. The data management system 102 may be locally based. For example, the data management system 102 may be physically housed in a structure on a farm.

The communication links 122 may be direct or indirect. A direct link may include a link between two devices where information is communicated from one device to the other without passing through an intermediary. For example, the direct link may include a Bluetooth™ connection, a Zigbee® connection, a Wifi Direct™ connection, a near-field communications (NFC) connection, an infrared connection, a wired universal serial bus (USB) connection, an ethernet cable connection, a fiber-optic connection, a firewire connection, a microwire connection, and so forth. In another example, the direct link may include a cable on a bus network. “Direct,” when used regarding the communication links 122, may refer to any of the aforementioned direct communication links.

An indirect link may include a link between two or more devices where data may pass through an intermediary, such as a router, before being received by an intended recipient of the data. For example, the indirect link may include a wireless fidelity (WiFi) connection where data is passed through a WiFi router, a cellular network connection where data is passed through a cellular network router, a wired network connection where devices are interconnected through hubs and/or routers, and so forth. The cellular network connection may be implemented according to one or more cellular network standards, including the global system for mobile communications (GSM) standard, a code division multiple access (CDMA) standard such as the universal mobile telecommunications standard, an orthogonal frequency division multiple access (OFDMA) standard such as the long term evolution (LTE) standard, and so forth. “Indirect,” when used regarding the communication links 122, may refer to any of the aforementioned indirect communication links. In general, the communication links 122 may form a communication network. The communication network may include a low-frequency radio network and/or a high-frequency radio network. For example, the communication network may include wireless communication on the 2.4 GHz ISM (industrial, scientific, and medical) band, the 5.8 GHz ISM band, the 433 MHz ISM band, the 915 MHz ISM band, the 1.3 GHz amateur radio band, the 868 MHz SRD (short-range device) band, and so forth. The communication network may operate using various protocols, such as a WiFi protocol, a Bluetooth™ protocol, a 2G protocol, a 3G protocol, a 4G protocol, a 4G LTE (long-term evolution) protocol, a 5G LTE protocol, a GSM™ (global system for mobile communications) protocol, and so forth. The communication network may be a local network, a wired network, a combination of wired and wireless communication, a public network, a private network, and so forth.

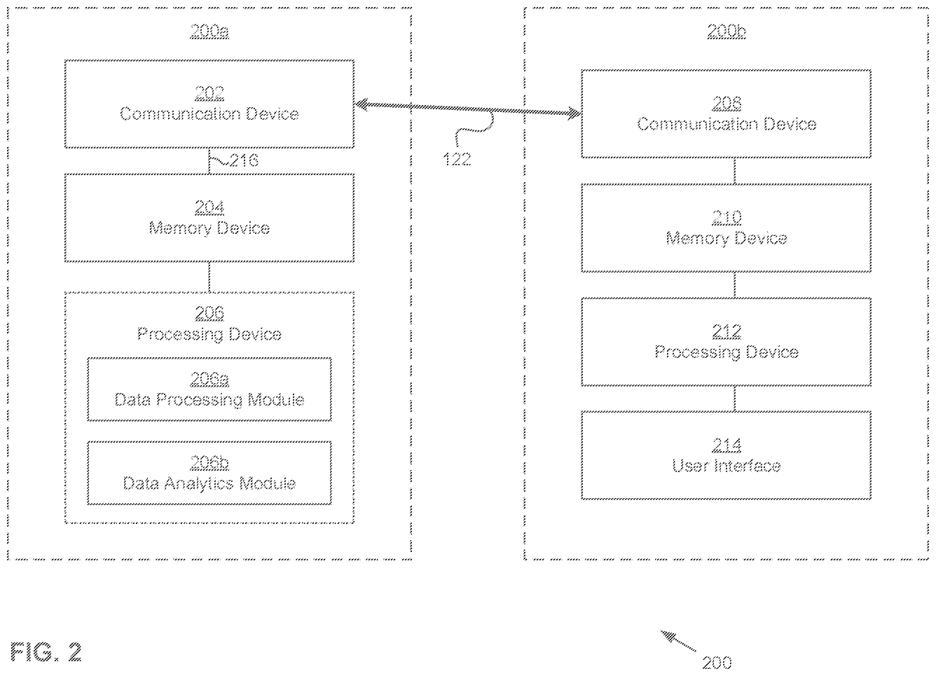

FIG. 2 illustrates a device schematic 200 for various devices used in the crop management system 100, according to an embodiment. A server device 200a may moderate data communicated to a client device 200b based on data permissions to minimize memory resource allocation at the client device 200b.

The server device 200a may include a communication device 202, a memory device 204, and a processing device 206. The processing device 206 may include a data processing module 206a and a data analytics module 206b, where module refers to specific programming that governs how data is handled by the processing device 206. The client device 200b may include a communication device 208, a memory device 210, a processing device 212, and a user interface 214. Various hardware elements within the server device 200a and/or the client device 200b may be interconnected via a system bus 216. The system bus 216 may be and/or include a control bus, a data bus, an address bus, and so forth. The communication device 202 of the server device 200a may communicate with the communication device 208 of the client device 200b.

The data processing module 206a may handle inputs from the client device 200b. The data processing module 206a may cause data to be written and stored in the memory device 204 based on the inputs from the client device 200b. The data processing module 206a may retrieve data stored in the memory device 204 and output the data to the client device 200b via the communication device 202. The data analytics module 206b may receive, as input, data indicative of an image, a sensor measurement, a location, and/or a task performed by a robot. The data analytics module 206b may pass the input data through an analytics model. The data analytics module 206b may output, based on the input and the analytics model, recommendation data, analysis data, and/or prediction data.

The server device 200a may be representative of the data management system 102. The server device 200a may be representative of the application server 108. The server device 200a may be representative of the data server 112. The server device 200a may be representative of the external application server 118. The memory device 204 may be representative of the database 110 and the processing device 206 may be representative of the data server 112. The memory device 204 may be representative of the external database 120 and the processing device 206 may be representative of the external application server 118. For example, the database 110 and/or the external database 120 may be implemented as a block of memory in the memory device 204. The memory device 204 may further store instructions that, when executed by the processing device 206, perform various functions with the data stored in the database 110 and/or the external database 120. Similarly, the client device 200b may be representative of the user device 104. The client device 200b may be representative of the smartphone 114. The client device 200b may be representative of the personal computer 116. The memory device 210 may store application instructions that, when executed by the processing device 212, cause the client device 200b to perform various functions associated with the instructions, such as retrieving data, processing data, receiving input, processing input, transmitting data, and so forth.

As stated above, the server device 200a and the client device 200b may be representative of various devices of the crop management system 100. Various of the elements of the crop management system 100 may include data storage and/or processing capabilities. Such capabilities may be rendered by various electronics for processing and/or storing electronic signals. One or more of the devices in the crop management system 100 may include a processing device. For example, the data management system 102, the user device 104, the observation robot 106, the smartphone 114, the personal computer 116, the external application server 118, and/or the external database 120 may include a processing device. One or more of the devices in the crop management system 100 may include a memory device. For example, the data management system 102, the user device 104, the observation robot 106, the smartphone 114, the personal computer 116, the external application server 118, and/or the external database 120 may include the memory device.

The processing device may have volatile and/or persistent memory. The memory device may have volatile and/or persistent memory. The processing device may have volatile memory and the memory device may have persistent memory. The processing device may generate an output based on an input. For example, the processing device may receive an electronic and/or digital signal. The processing device may read the signal and perform one or more tasks with the signal, such as performing various functions with data in response to input received by the processing device. The processing device may read from the memory device information needed to perform the functions. For example, the processing device may update a variable from static to dynamic based on a received input and a rule stored as data on the memory device. The processing device may send an output signal to the memory device, and the memory device may store data according to the signal output by the processing device.

The processing device may be and/or include a processor, a microprocessor, a computer processing unit (CPU), a graphics processing unit (GPU), a neural processing unit, a physics processing unit, a digital signal processor, an image signal processor, a synergistic processing element, a field-programmable gate array (FPGA), a sound chip, a multi-core processor, and so forth. As used herein, “processor,” “processing component,” “processing device,” and/or “processing unit” may be used generically to refer to any or all of the aforementioned devices, elements, and/or features of the processing device. The memory device may be and/or include a computer processing unit register, a cache memory, a magnetic disk, an optical disk, a solid-state drive, and so forth. The memory device may be configured with random access memory (RAM), read-only memory (ROM), static RAM, dynamic RAM, masked ROM, programmable ROM, erasable and programmable ROM, electrically erasable and programmable ROM, and so forth. As used herein, “memory,” “memory component,” “memory device,” and/or “memory unit” may be used generically to refer to any or all of the aforementioned devices, elements, and/or features of the memory device.

Various of the devices in the crop management system 100 may include data communication capabilities. Such capabilities may be rendered by various electronics for transmitting and/or receiving electronic and/or electromagnetic signals. One or more of the devices in the crop management system 100 may include a communication device, e.g., the communication device 202 and/or the communication device 208. For example, the data management system 102, the user device 104, the observation robot 106 the smartphone 114, the personal computer 116, the external application server 118, and/or the external database 120 may include a communication device.

The communication device may include, for example, a networking chip, one or more antennas, and/or one or more communication ports. The communication device may generate radio frequency (RF) signals and transmit the RF signals via one or more of the antennas. The communication device may receive and/or translate the RF signals. The communication device may transceive the RF signals. The RF signals may be broadcast and/or received by the antennas.

The communication device may generate electronic signals and transmit the RF signals via one or more of the communication ports. The communication device may receive the RF signals from one or more of the communication ports. The electronic signals may be transmitted to and/or from a communication hardline by the communication ports. The communication device may generate optical signals and transmit the optical signals to one or more of the communication ports. The communication device may receive the optical signals and/or may generate one or more digital signals based on the optical signals. The optical signals may be transmitted to and/or received from a communication hardline by the communication port, and/or the optical signals may be transmitted and/or received across open space by the networking device.

The communication device may include hardware and/or software for generating and communicating signals over a direct and/or indirect network communication link. For example, the communication component may include a USB port and a USB wire, and/or an RF antenna with Bluetooth™ programming installed on a processor, such as the processing component, coupled to the antenna. In another example, the communication component may include an RF antenna and programming installed on a processor, such as the processing device, for communicating over a Wifi and/or cellular network. As used herein, “communication device” “communication component,” and/or “communication unit” may be used generically herein to refer to any or all of the aforementioned elements and/or features of the communication component.

Various of the elements in the crop management system 100 may be referred to as a “server.” Such elements may include a server device. The server device may include a physical server and/or a virtual server. For example, the server device may include one or more baremetal servers. The bare-metal servers may be single-tenant servers or multiple tenant servers. In another example, the server device may include a bare metal server partitioned into two or more virtual servers. The virtual servers may include separate operating systems and/or applications from each other. In yet another example, the server device may include a virtual server distributed on a cluster of networked physical servers. The virtual servers may include an operating system and/or one or more applications installed on the virtual server and distributed across the cluster of networked physical servers. In yet another example, the server device may include more than one virtual server distributed across a cluster of networked physical servers.

The term server may refer to functionality of a device and/or an application operating on a device. For example, an application server may be programming instantiated in an operating system installed on a memory device and run by a processing device. The application server may include instructions for receiving, retrieving, storing, outputting, and/or processing data. A processing server may be programming instantiated in an operating system that receives data, applies rules to data, makes inferences about the data, and so forth. Servers referred to separately herein, such as an application server, a processing server, a collaboration server, a scheduling server, and so forth may be instantiated in the same operating system and/or on the same server device. Separate servers may be instantiated in the same application or in different applications.

Various aspects of the systems described herein may be referred to as “data.” Data may be used to refer generically to modes of storing and/or conveying information. Accordingly, data may refer to textual entries in a table of a database. Data may refer to alphanumeric characters stored in a database. Data may refer to machine-readable code. Data may refer to images. Data may refer to audio. Data may refer to, more broadly, a sequence of one or more symbols. The symbols may be binary. Data may refer to a machine state that is computer-readable. Data may refer to human-readable text.

Various of the devices in the crop management system 100, including the server device 200a, the client device 200b, and/or the observation robot 106, may include a user interface for outputting information in a format perceptible by a user and receiving input from the user, e.g., the user interface 214. The user interface may include a display screen such as a light-emitting diode (LED) display, an organic LED (OLED) display, an active-matrix OLED (AMOLED) display, a liquid crystal display (LCD), a thin-film transistor (TFT) LCD, a plasma display, a quantum dot (QLED) display, and so forth. The user interface may include an acoustic element such as a speaker, a microphone, and so forth. The user interface may include a button, a switch, a keyboard, a touch-sensitive surface, a touchscreen, a camera, a fingerprint scanner, and so forth. The touchscreen may include a resistive touchscreen, a capacitive touchscreen, and so forth.

The client device 200b may have installed thereon a user device application (UDA) associated with the crop management system 100. The UDA may, for example, be a software application running on a mobile device, a web browser on a computer, an application on a dedicated computing device, and so forth. The UDA may include instructions for executing various methods and/or functions described herein. In various implementations, the UDA may include instructions that, when executed, retrieve from a server an image, a geotagged image, crop data, and/or geo-tagged crop data. Geotag is defined as an indication that a particular data point or image has been collected from a certain location in the farm. The data point could be through GPS tagging or other mapping or localization methods. The UDA may be programmed with instructions to display the retrieved information via, for example, the user interface 214. The UDA may include instructions for generating a graphical user interface that includes one or more tools. The tools may, for example, enable receiving inputs such as label manipulation, anomaly identification, navigation schedule adjustment, navigation path adjustment, or a command for the observation robot 106 to perform a particular task. The tools may enable control of two or more observation robots 106.

In various implementations, the UDA may include instructions that, when executed, generate a virtual tour of a farm for display at the user interface. The virtual tour may be generated by stitching together and displaying geotagged images and/or data. The virtual tour may imitate a physical tour by displaying images of adjacent locations sequentially. The virtual tour may include images of the crops, such as rows of plants and/or individual plants, with a perspective similar to a perspective the user would experience in situ. Additionally or alternatively, various images may be displayed simultaneously in the form of a panoramic image by stitching adjacent images together and aligning them according to a geo-tag. The geo-tag may, for example, be acquired by a GPS and/or a robot mapping application. The UDA may be configured to receive one or more inputs, such as a selection of a section of the panoramic image. In response to the selection, the image and/or images corresponding to the selected section may be enlarged (e.g., the panoramic image may be zoomed in on the selected section). The enlarged image may show in greater detail particular areas and/or plants within a row of crops.

In various implementations, the UDA may include instructions that, when executed, cause the user interface to display a notification. The notification may indicate a problem, potential problem, and/or anomaly detected in the farm. For example, the observation robot 106 may identify a fungus growing on a plant by using an onboard processing device programmed with an analytics model for processing images to identify the fungus. The observation robot 106 may generate and/or transmit the notification to the client device 200b and/or the server device 200a. The UDA may cause the notifications, anomalies, problems, and/or associated images and/or data to be displayed via the user interface 214. The UDA may include instructions associated with one or more inputs in response to the displayed information. For example, the information may be ignored (e.g., be dismissing the information via a direct input or no input), a label may be modified, an action may be recommended, an action may be initiated, and so forth. The recommended action may be an action by the observation robot 106, a farmworker, or other farm machinery. The initiated action may, for example, be an action by an automated or semiautomated farm machine.

Anomaly detection may be performed at the client device 200b. For example, the client device 200b may store one or more instructions associated with an analytics program that analyzes data collected by one or more observation robots 106. Anomaly detection may be performed at the server device 200a. Anomaly detection may be performed at one or more observation robots 106. The system may timestamp the data collected such as timestamping the images taken by the camera. The timestamp being defined as the time, date or other indications of time that some data has been collected.

In various implementations, the images may include aerial images of their farm from an aerial perspective such as a satellite view or a birds-eye view captured using an aerial drone. Anomalies or problem areas within the farm may be pinpointed in the aerial images. An input instruction may be associated with a selection of a portion of the aerial image. The input instruction may include receiving a click or tap input and, in response, displaying a more detailed image, data, and/or other information about the selected area. The input instruction may include, in response to receiving the input, displaying a ground-level virtual tour or panoramic image of the selected area.

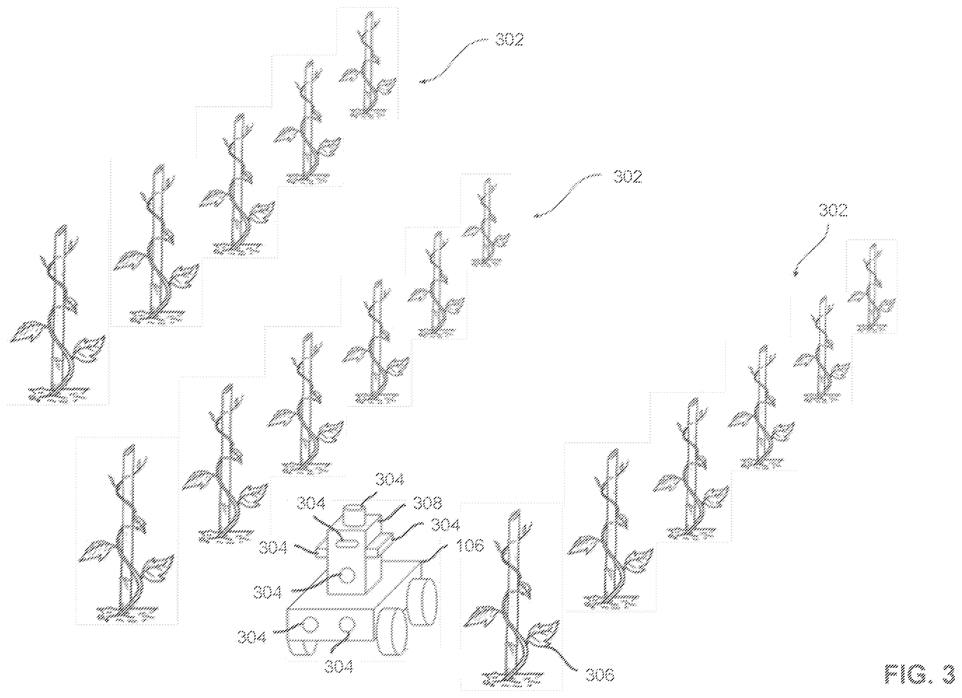

FIG. 3 illustrates the observation robot 106 navigating rows of crops 302, according to an embodiment. By navigating through rows of crops, the observation robot 106 may be able to acquire information and/or data not readily apparent to a farmworker. The observation robot 106 may collect information tagged with precise location data, which may enable farmers to more precisely identify and address problems with crops.

The observation robot 106 may be a land-based device that traverses the rows of crops 302 on the ground. For example, the observation robot 106 may include wheels and/or tracks that enable the observation robot 106 to travel on the ground between the rows of crops 302. Additionally or alternatively, the observation robot 106 may be an air-based device that traverses the rows of crops 302 in the air. For example, the observation robot 106 may be a flying drone with one or more propellers that enable the observation robot 106 to fly over the rows of crops 302.

The observation robot 106 may include one or more sensors 304. The sensors 304 may take measurements and/or collect data from individual plants 306 in the rows of crops 302. The sensors 304 may collect position data for the observation robot 106 and/or the individual plants 306. The position data may be absolute, such as via a GPS sensor, or may be relative, such as by using identifiers for particular rows and/or particular plants. The sensor 304 may include an RGB (red-green-blue) camera (i.e., a visible light camera), a time of flight (TOF) camera, two or more stereo cameras, a depth camera, a lidar device, an ultrasound sensor, a radar device, a thermal camera, an infrared camera and/or sensor, an inertial measurement unit (IMU), a global positioning sensor (GPS), an encoder that detects and/or records wheel and/or track movement, a CO2 sensor, an oxygen sensor, a barometer, a temperature sensor, and/or a microphone. The observation robot 106 may include a right and a left set of the sensors 304. The sensors 304 may include a monocular camera and a thermal camera.

The observation robot 106 may include a processing unit. The processing unit may, for example, be positioned inside a compartment 308 of the observation robot 106. The processing unit may store and/or execute various instructions for operating the sensors 304. The processing unit may store and/or execute various instructions for navigating the observation robot 106. For example, the instructions may enable the observation robot 106 to navigate along designated paths among the rows of crops 302. The instructions may enable the observation robot 106, via the sensor 304, to identify a path between the rows of crops 302. The instructions may enable the observation robot 106 to determine a flight path.

As the observation robot 106 traverses the rows of crops 302, one or more of the sensors 304 may collect information about the individual plants 306. For example, a camera may take one or more pictures of a plant. The observation robot 106 may take pictures continuously and/or intermittently. For example, the observation robot 106 may traverse the rows of crops 302 at a steady or approximately steady rate and may take pictures of the individual plants 306 at predetermined intervals. The intervals may be determined based on plant spacing. The intervals may be selected to capture multiple images of the individual plants 306 from various sides of the individual plants. The sensors 304 may enable precise identification of the individual plants 306. As images are captured, the images may be tagged with location and/or identification information for the individual plants 306. The observation robot 106 may capture images of the same plant from opposite sides of the plant. For example, the observation robot 106 may traverse the inter-row spaces on either side of an individual row of plants. The sensors 304 may enable identification of a particular plant from both inter-row spaces on either side of the particular plant.

In various implementations, the sensors 304 may collect other data from the individual plants 306. For example, the sensors 304 may collect temperature information. The temperature information may be used to generate a heat map for a field or a portion of the field. The sensors 304 may collect information on the shape of plants to determine growth rate and/or yield of the individual plants 306. The sensors 304 may collect information about stalk density. The sensors 304 may collect information about the amount of sunlight reaching a particular plant. The sensors 304 may collect information about pests, such as by identifying particular pests and/or signs on the individual plants 306 of the pests.

The observation robot 106 may collect data simultaneously from two adjacent rows of plants using sensors mounted on both sides of the observation robot 106. Accordingly, the observation robot 106 may traverse an inter-row space once and collect information for plants on both sides of the inter-row space.

The observation robot 106 may have sensors 304 facing one direction, such as to one side of the observation robot 106. The observation robot 106 may have sensors 304 facing opposite directions to monitor, survey, and/or image two adjacent rows at the same time. The observation robot 106 may collect data, images, and/or videos from two adjacent rows of crops that are on the left and right sides of the observation robot 106 as it navigates between the two rows. One set of cameras and/or sensors may face the left side of the observation robot 106, and one set of cameras and/or sensors may face the right side of the robot. A set of cameras and/or sensors may include monocular cameras, stereo cameras, depth cameras, thermal cameras, infra-red (IR) cameras, lidars, TOF cameras, radars, and so forth. Images and data from sensors 304 may be stored in memory on the observation robot 106. The images and data may be transmitted to another device, such as the user device 104 and/or a device of the data management system 102. The images and/or data may be passed through a machine learning (ML) algorithm to train an ML model or perform an inference task. Additionally or alternatively, other telemetry data such as ambient temperature, humidity, elevation, geo-location, day of the year, type, and sub-category of crops, and so forth may also be stored and used to train the ML model or perform inference. Such a robust data set may improve predictive and/or analytical accuracy of the ML model.

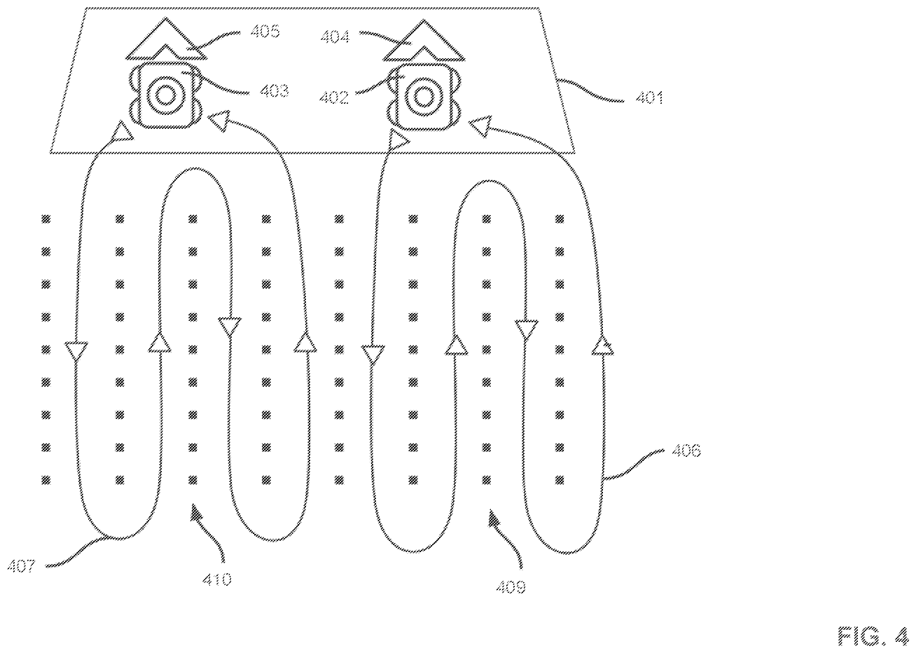

FIG. 4 illustrates an example navigation plan for a set of the observation robots 106, according to an embodiment. In various implementations, multiple observation robots 106 may be used to monitor a field. This may increase how quickly and efficiently data is gathered, enabling farmers to be more responsive to issues with their crops. Having multiple observation robots 106 may make it easier to respond to and/or adjust for break-downs. Having multiple observation robots 106 may make it easier to respond to and/or adjust for an out-of-service observation robot 106. Having multiple observation robots 106 may enable greater in-field data storage capacity. More types and amounts of data may be collected by an individual observation robot 106, which in turn may increase the capacity for various ML models to accurately analyze crop data and/or predict events such as crop yield. Multiple observation robots 106 may reduce the total time it takes to collect data, such as for large and/or expansive sites or fields.

A first robot 402 and/or a second robot 403, which robots may be implementations of the observation robot 106, may be housed in and/or at a warehouse and/or station 401. Additionally or alternatively, the first robot 402 and the second robot 403 may be housed inside different warehouses and/or stations. A first charging station 404 may correspond to and/or be designated for the first robot 402. A second charging station 405 may correspond to and/or be designated for the second robot 403. The first charging station 404 and/or the second charging station may accommodate multiple observation robots 106. An implementation of the crop management system 100 with two or more observation robots 106 may include one charging station for the two or more observation robots 106. A number of charging stations for the crop management system 100 may be based on a number of the observation robots 106 and/or a navigation plan for the observation robots 106 or several robots may share a number of charging platforms. For example, a navigation plan for a set of three observation robots 106 may allow for one observation robot 106 to charge while the other two traverse the crops. When the observation robot 106 is finished charging, the other observation robot 106 with the lowest battery may navigate to the charging station.

In one implementation, a field may include a first set of crop rows 409 and a second set of crop rows 410. The first robot 402 may follow a first navigation path 406 through the first set of crop rows 409. The second robot 403 may follow a second navigation path 407 through the second set of crop rows 410. The first robot 402 and/or the second robot 403 may be autonomous or partially autonomous. For example, the first robot 402 and/or the second robot 403 may be programmed to navigate the rows of crops on a set schedule. The first robot 402 and/or the second robot 403 may be programmed with autonomous navigation instructions. For example, the first robot 402 and/or the second robot 403 may be programmed to identify a navigation path using lidar and/or a TOF sensor. The first robot 402 and/or the second robot 403 may be programmed to follow a route based on a GPS signal. The first robot 402 and/or the second robot 403 may use lidar and/or a TOF sensor to identify and/or navigate around obstructions. The first robot 402 and/or the second robot 403 may be programmed to follow a route based on camera, IMU, wheel odometer, and/or other sensors.

The first robot 402 and/or the second robot 403 may be programmed with instructions for returning to its respective charging station. Such instructions may include a rule such as an if then rule. For example, the instructions may include a rule that, if the observation robot's 106 battery level reaches a certain level, then the observation robot 106 re-navigates back to the charging station. As another example, the instructions may include iteratively calculating the amount of charge that would be necessary to return to a charging station based on the current location of the observation robot 106. When the charge necessary to return is within a threshold range of a current charge, the observation robot may automatically renavigate to the charging station. As yet another example, the observation robot 106 may poll a set of charging stations to determine the nearest charging station that is available. A charging station may be indicated as unavailable when an observation robot 106 is currently charging at the station and/or when an observation robot 106 is traveling to the charging station. The observation robot 106 may communicate with the charging station and/or other observation robots 106 to indicate its current navigation path. In various implementations, the observation robot 106 may automatically renavigate, or navigate back based on a plan, in response to one or more factors, such as a low battery, low memory, bad weather condition, bad weather forecast, the end of a task, and so forth.

In various implementations, navigation of a field may be based on a pre-determined map of the farm. The map may be a row-wise map, where navigation paths are designated as avenues between blocked-out rows. In such an implementation, individual plants may not be indicated on the map. The map may be a plant-oriented map, where individual plants are indicated on the map and navigation paths are designated based on the locations of the individual plants. The map of the farm may be generated through pre-existing knowledge of the farm layout, manual surveying of the farm, surveying of the farm using an unmanned aerial vehicle (UAV), using a satellite map of the area, and so forth. Additional information such as slope, smoothness, ruggedness, and/or traversability of the rows may be added to the map. Such information may, for example, be obtained by survey, based on a previously-determined topographical map, based on aerial observation using, for example, lidar, and so forth.

Various speed settings of the observation robot 106 may be set based on one or more factors. The observation robot 106 may have a variable speed and may be programmed to traverse flat and/or smooth topography faster than rough topography. The observation robot 106 may be programmed to traverse at a first speed while taking measurements and at a second speed when navigating to the charging station and/or from the charging station to a portion of the field the observation robot 106 is designated to monitor. The observation robot 106 may be programmed to maintain an average speed based on battery consumption. The average speed may be set to ensure a battery of the observation robot 106 has enough charge to complete a particular task and return to the charging station. The observation robot 106 may be programmed with a maximum speed. For example, the maximum speed may be based on a safety parameter for workers to ensure workers are not injured by the observation robot 106. The observation robot 106 may be programmed with a preferred speed and/or preferred average speed. The preferred speed may be based on an amount of time it would take at the preferred speed to traverse a particular section of the farm.

In various implementations, the battery capacity of the observation robot 106 may be a factor in determining a navigation plan and/or speed for the observation robot 106. Based on the battery capacity, operation factors may be calculated. An operation factor may be, for example, a maximum distance the observation robot 106 may travel from the charging station. An operation factor may be a number of rows the observation robot 106 is capable of traversing given a certain battery capacity. The number of rows may be further determined based on the length of the rows and/or the slope of the terrain.

In one example, the first navigation path 406 may have a five percent uphill grade in one direction and a five percent downhill grade in the opposite direction. The rows may be approximately 500 meters long. Battery consumption for the observation robot 106 at a speed of one meter per second on the uphill grade may be approximately 0.05% per meter. For the downhill grade and at the same speed, battery consumption may be approximately 0.03% per meter. The uphill traverse of a row may accordingly deplete the battery by 25% (i.e., 500 meters×0.05% depletion per meter). The downhill traverse may deplete the battery by 15%. The battery of the observation robot 106 may be depleted by approximately 80% after traversing four adjacent rows following the first navigation path 406. Further travel of the observation robot 106 may result in complete battery depletion in the middle of a row. Accordingly, the observation robot 106 may be programmed to return to the charging station after traversing four adjacent rows.

In various implementations, a farm may be too large for a single observation robot 106 to survey in one pass (i.e., using one charge). Accordingly, a fleet of observation robots 106 may be employed. The number of observation robots 106 in the fleet may be determined automatically by a processing device based on values for various factors. The size of the fleet may be determined and/or selected by a user. The number of observation robots 106 in the fleet may be determined based on one or more factors, such as the size of the farm, the number of rows, the length of the rows, the slope of the terrain, the variation in the slope of the terrain, a frequency at which the farm is to be surveyed, the speed of the observation robots 106, the battery capacity of the observation robots 106, and so forth.

Various of the factors may be set manually by a user according to preference, such as the survey frequency. Survey frequency may be determined by a user or may be automatically determined. For example, survey frequency may be automatically determined based on the type of crop, the time of season, the stage of growth, a known change in one or more crop growth factors, and so forth. In one implementation, the survey frequency may be determined to be one full survey of the farm every five days. In another implementation, the survey frequency may be determined to be one full survey every three days. In yet another implementation, the survey frequency may be determined to be one full survey daily.

Having multiple observation robots 106 may enable a field to be surveyed more quickly than by a single observation robot 106. For example, a first robot may traverse a first avenue adjacent to a crop row. A second robot may traverse a second avenue opposite the crop row from the first avenue. The first robot may collect data such as images, sensor measurements, telemetry, and so forth along a first side of the crop row. For example, the first robot may capture images of the crop row along the first side. The second robot may collect similar and/or different data along a second side of the crop row. For example, the second robot may capture images of the crop row along the second side. The images captured by the first and second robots may be combined to analyze the health of the crop row, predict yield, identify pests, and so forth. Using two observation robots 106 may cut the number of passes by the observation robots 106 in half, in turn cutting in half the amount of time to survey the field. A navigation path for an individual observation robot 106 may be determined by a processing device of the observation robot 106. The navigation path may be determined at a server and communicated to the observation robot 106. The server may determine navigation paths for a set of observation robots 106. The navigation paths may be coordinated. For example, the navigation paths may be coordinated based on the size and/or layout of the farm, the number of observation robots 106 in the fleet, the number and/or location of the charging stations, and/or the survey frequency.

In some implementations, it may be more efficient to determine the navigation path at the observation robot 106. For example, the observation robot 106 may be enabled via hardware and/or programming to identify humans. The observation robot 106 may further be programmed to generate a new navigation path when human workers are observed on the current navigation path. In some implementations, it may be more efficient to determine the navigation path at a centralized server. The centralized server may have sufficient processing bandwidth to perform multi-factor analysis in determining optimal and/or near-optimal navigation paths for a fleet of observation robots 106. The centralized server may further have ready access to information about various factors not readily available to an individual observation robot 106 in the field. Such factors may include, for example, a farm layout map, terrain information, and specifications for the observation robots 106 (e.g., when the fleet includes various observation robots 106 with different capabilities and/or limitations).

In one example, a multi-robot coverage path planning may include dividing rows into subsets that may be navigated in one pass by an available number of observation robots 106. Another technique for coverage path planning in multi-robot systems may include decomposing an area into rows and using the resulting graph to determine individual observation robot 106 routing. In the same or other implementations, row assignments for individual observation robots 106 in the fleet may be determined according to the Hungarian method.

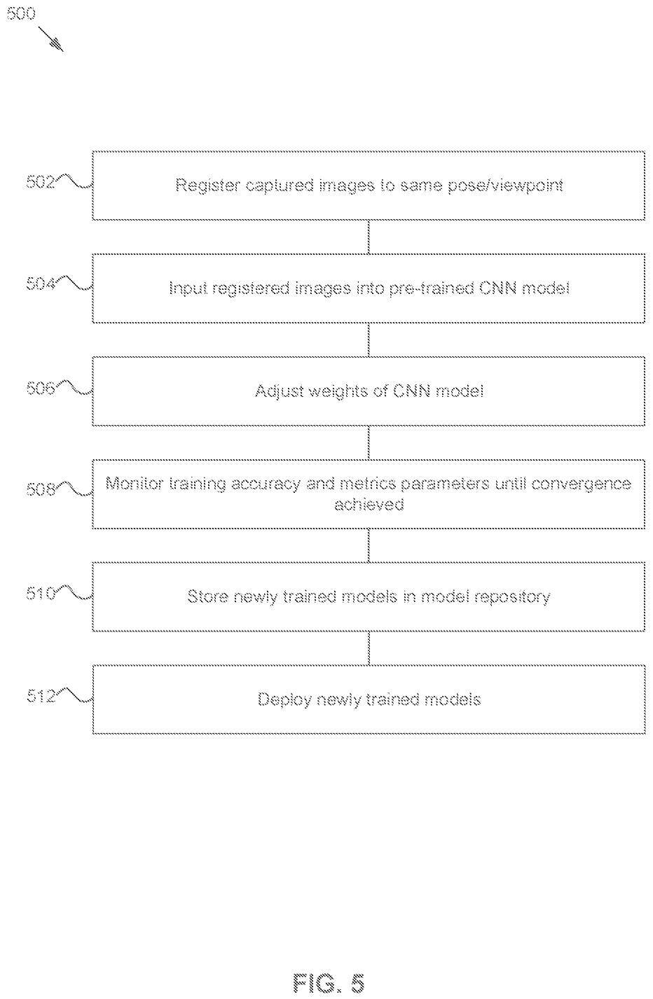

FIG. 5 illustrates a method 500 of training an ML model, according to an embodiment. The method 500 may result in ML models that are more accurate and/or efficient than previous or conventional analysis models. The method 500 may result in various ML models capable of determining various outputs and/or predictions based on multiple inter-dependent variables. For example, in regions where rainfall is the primary watering source for crops, an amount of sunlight exposure may be inversely proportional to an amount of rainfall. Both factors may be directly proportional to crop growth. The method 500 may result in ML models capable of identifying drivers of negative and/or positive outcomes based on the multiple interdependent variables.

During an inference phase, an ML model may be used at the observation robot 106 and/or at a server to perform an inference task such as classification, detection, segmentation, or forecasting on the input data and images. An ML model may be used at the observation robot 106 to detect people, plants, rocks, and/or obstacles as the observation robot 106 navigates a field or site. ML inference tasks may employ a trained convolutional neural network (CNN) model. For example, various captured images and data of a particular scene, along with other relevant telemetry data, may be provided as input to a trained CNN model. Telemetry data may be concatenated with one or more images and fed to an enhanced CNN model to generate one or more inferences for a particular plant or row of plants.

The ML model may be a CNN model or an enhanced CNN model. The CNN/enhanced CNN model may accept as input at least some of the data collected by the observation robot 106. The ML model may be trained using various techniques, such as Bayes rules, backpropagation techniques using gradient descent, stochastic gradient techniques, and so forth.

The method 500 may be implemented to train a CNN model. The method 500 may include registering captured images to correspond to the same pose and/or viewpoint of a scene (block 502). The method 500 may include inputting the images to a pre-trained CNN model such as a pre-trained VGG-16 or Resnet-50 model (block 504). The images may be input into models trained according to the method 500 to further refine the models. The method 500 may include adjusting the weights of the CNN model using stochastic gradient descent (block 506). The method 500 may include monitoring training accuracy and metrics parameters until model convergence is achieved (block 508). The method 500 may include storing the newly-trained models in a model repository (block 510). The method 500 may include deploying the newlytrained models to a server and/or an observation robot 106 (block 512).

In various implementations, the training of the ML models may include supervised machine learning using labeled images and/or data. For example, previously identified anomalies, crop types, or pests may be used as labels to train the ML models. Such labeling may be performed or modified, for instance, by a human via a computer program or application that monitors the captured images and data. Additionally or alternatively, the labeling may be performed by a commercial image labeling platform, such as a platform that outsources the labeling task to one or more human labelers.

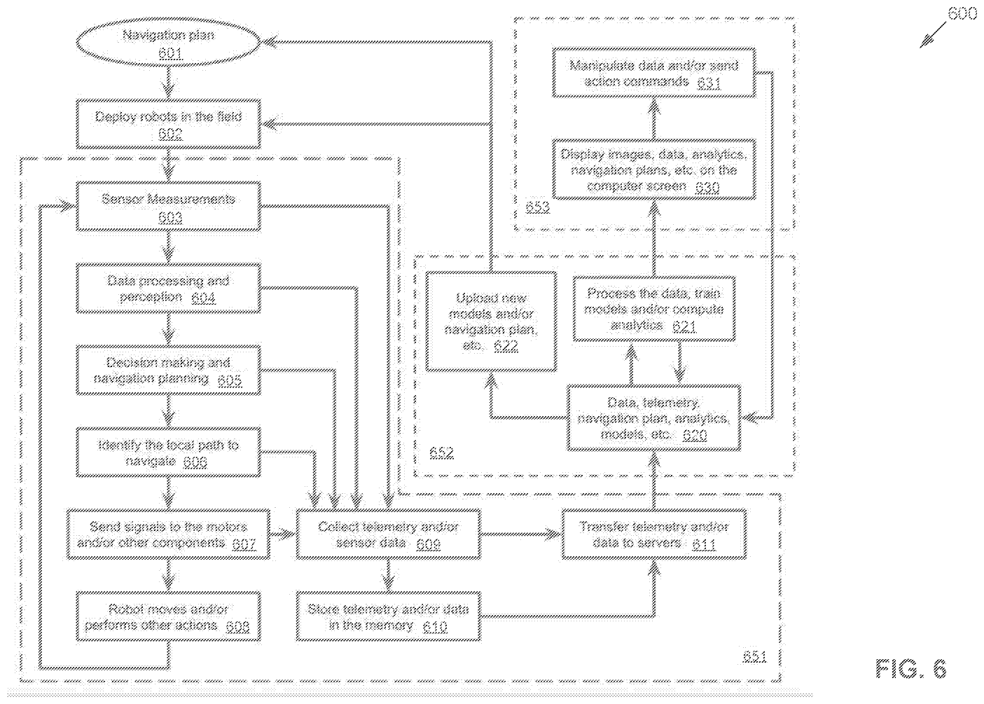

FIG. 6 illustrates a method 600 of collecting and analyzing crop data, according to an embodiment. The method 600 may be implemented using, for example, the crop management system 100. The method 600 may enable a farmer to obtain a holistic and accurate analytical picture of the farmer's crops. In turn, this may enable the farmer to make decisions based on anticipated crop yield, respond promptly to crop issues before significant crop degradation occurs, and so forth. Overall, implementation of the method 600 using the crop management system 100 may result in a healthier crop with a higher yield at a lower cost and, therefore, greater profitability.

The method 600 may include various elements executed at and/or by a robot and/or drone such as the observation robot 106 (block 651). The method 600 may include various elements executed at and/or by a server such as the data server 112 (block 652). The method 600 may include various elements executed at and/or by a user device such as the user device 104 (block 653).

The method 600 may include determining a navigation plan for an observation robot 106 (block 601). The method 600 may include deploying the observation robot 106 to a field (block 602). The method 600 may include obtaining one or more sensor measurements (block 603). The method 600 may include processing data associated with the one or more sensor measurements to output environmental and/or crop perception data (block 604). The method 600 may include determining a set of tasks and/or an updated navigation plan (block 605). The set of tasks and/or the updated navigation plan may be based at least in part on the environmental and/or crop perception data.

The method 600 may include identifying a local path to navigate (block 606). The local path may be identified based on the navigation plan and/or the updated navigation plan. The method 600 may include activating various components of the robot (block 607). The components may, for example, include a motor, a sensor, an actuator, and so forth. The method 600 may include executing various tasks associated with the navigation plan and/or the updated navigation plan (block 608). The tasks may include, for example, traversing a path identified in the navigation plan, taking one or more measurements, transmitting data recorded based on the one or more measurements, and so forth.

The method 600 may include collecting telemetry and/or sensor data (block 609). The telemetry and/or sensor data may be collected continuously as the method 600 is executed. The telemetry and/or sensor data may be collected iteratively throughout the method 600. The method 600 may include storing the telemetry and/or sensor data (block 610). The telemetry and/or sensor data may be stored locally in memory integrated with or otherwise coupled to the robot. The method 600 may include transmitting the telemetry and/or sensor data to a server device (block 611). The data may be transmitted via a wireless network as the robot is in the field. For example, the robot may be programmed to automatically upload recorded data to the server device when a threshold memory usage is reached. The data may be transmitted via a wired or wireless network when the robot is charging. For example, the charging station may include a charging dock and a data dock. The robot may include corresponding ports for the charging dock and the data dock. Additionally or alternatively, the charging station may include a dock configured to transfer data and power, and the robot may include a similar charging/data port. The charging station may include a port and the robot may include a dock.

The method 600 may include inputting the telemetry and/or sensor data into an analytics model such as an ML model (block 620). The method 600 may include processing the telemetry and/or sensor data, training the analytics model, and/or determining various outputs using the analytics model (block 621). In various implementations, an output may be an updated navigation plan. a treatment plan for crop disease, a crop yield prediction, and so forth. The method 600 may include uploading an updated analytics model and/or navigation plan to the robot (block 622).

The method 600 may include generating a display for the user device (block 630). The display may, for example, be a web page sent to a web browser of a personal computer. The display may, for example, be a graphical user interface in a native application installed on a smartphone. The display may include various elements such as an image, data, analytics such as a crop condition report, a recommendation, a navigation plan, and so forth. The method 600 may include receiving, via the user device, one or more inputs (block 631). The inputs may include manipulation of the data presented in the graphical user interface, for example. The inputs may include action commands for the server device and/or the robot.

A feature illustrated in one of the figures may be the same as or similar to a feature illustrated in another of the figures. Similarly, a feature described in connection with one of the figures may be the same as or similar to a feature described in connection with another of the figures. The same or similar features may be noted by the same or similar reference characters unless expressly described otherwise. Additionally, the description of a particular figure may refer to a feature not shown in the particular figure. The feature may be illustrated in and/or further described in connection with another figure.

Elements of processes (i.e., methods) described herein may be executed in one or more ways such as by a human, by a processing device, by mechanisms operating automatically or under human control, and so forth. Additionally, although various elements of a process may be depicted in the figures in a particular order, the elements of the process may be performed in one or more different orders without departing from the substance and spirit of the disclosure herein.

The foregoing description sets forth numerous specific details such as examples of specific systems, components, methods and so forth, in order to provide a good understanding of several implementations. It will be apparent to one skilled in the art, however, that at least some implementations may be practiced without these specific details. In other instances, well-known components or methods are not described in detail or are presented in simple block diagram format in order to avoid unnecessarily obscuring the present implementations. Thus, the specific details set forth above are merely exemplary. Particular implementations may vary from these exemplary details and still be contemplated to be within the scope of the present implementations.

Related elements in the examples and/or embodiments described herein may be identical, similar, or dissimilar in different examples. For the sake of brevity and clarity, related elements may not be redundantly explained. Instead, the use of a same, similar, and/or related element names and/or reference characters may cue the reader that an element with a given name and/or associated reference character may be similar to another related element with the same, similar, and/or related element name and/or reference character in an example explained elsewhere herein. Elements specific to a given example may be described regarding that particular example. A person having ordinary skill in the art will understand that a given element need not be the same and/or similar to the specific portrayal of a related element in any given figure or example in order to share features of the related element.

It is to be understood that the foregoing description is intended to be illustrative and not restrictive. Many other implementations will be apparent to those of skill in the art upon reading and understanding the above description. The scope of the present implementations should, therefore, be determined with reference to the appended claims, along with the full scope of equivalents to which such claims are entitled.

The foregoing disclosure encompasses multiple distinct examples with independent utility. While these examples have been disclosed in a particular form, the specific examples disclosed and illustrated above are not to be considered in a limiting sense as numerous variations are possible. The subject matter disclosed herein includes novel and non-obvious combinations and sub-combinations of the various elements, features, functions and/or properties disclosed above both explicitly and inherently. Where the disclosure or subsequently filed claims recite “a” element, “a first” element, or any such equivalent term, the disclosure or claims is to be understood to incorporate one or more such elements, neither requiring nor excluding two or more of such elements.

As used herein “same” means sharing all features and “similar” means sharing a substantial number of features or sharing materially important features even if a substantial number of features are not shared. As used herein “may” should be interpreted in a permissive sense and should not be interpreted in an indefinite sense. Additionally, use of “is” regarding examples, elements, and/or features should be interpreted to be definite only regarding a specific example and should not be interpreted as definite regarding every example. Furthermore, references to “the disclosure” and/or “this disclosure” refer to the entirety of the writings of this document and the entirety of the accompanying illustrations, which extends to all the writings of each subsection of this document, including the Title, Background, Brief description of the Drawings, Detailed Description, Claims, Abstract, and any other document and/or resource incorporated herein by reference.

As used herein regarding a list, “and” forms a group inclusive of all the listed elements. For example, an example described as including A, B, C, and D is an example that includes A, includes B, includes C, and also includes D. As used herein regarding a list, “or” forms a list of elements, any of which may be included. For example, an example described as including A, B, C, or D is an example that includes any of the elements A, B, C, and D. Unless otherwise stated, an example including a list of alternatively-inclusive elements does not preclude other examples that include various combinations of some or all of the alternatively-inclusive elements. An example described using a list of alternatively-inclusive elements includes at least one element of the listed elements. However, an example described using a list of alternatively-inclusive elements does not preclude another example that includes all of the listed elements. And an example described using a list of alternatively-inclusive elements does not preclude another example that includes a combination of some of the listed elements. As used herein regarding a list, “and/or” forms a list of elements inclusive alone or in any combination. For example, an example described as including A, B, C, and/or D is an example that may include: A alone; A and B; A, B and C; A, B, C, and D; and so forth. The bounds of an “and/or” list are defined by the complete set of combinations and permutations for the list.

Where multiples of a particular element are shown in a FIG., and where it is clear that the element is duplicated throughout the FIG., only one label may be provided for the element, despite multiple instances of the element being present in the FIG. Accordingly, other instances in the FIG. of the element having identical or similar structure and/or function may not have been redundantly labeled. A person having ordinary skill in the art will recognize based on the disclosure herein redundant and/or duplicated elements of the same FIG. Despite this, redundant labeling may be included where helpful in clarifying the structure of the depicted examples.

The Applicant(s) reserves the right to submit claims directed to combinations and subcombinations of the disclosed examples that are believed to be novel and non-obvious. Examples embodied in other combinations and sub-combinations of features, functions, elements, and/or properties may be claimed through amendment of those claims or presentation of new claims in the present application or in a related application. Such amended or new claims, whether they are directed to the same example or a different example and whether they are different, broader, narrower, or equal in scope to the original claims, are to be considered within the subject matter of the examples described herein.

What is claimed is:

1. A system, comprising:
a robot configured to navigate an agricultural field, the robot comprising:
a sensor that takes one or more measurements used by the robot to navigate the agricultural field;
at least one left-facing camera;
at least one right-facing camera;
a processing device; and
a memory device storing first instructions executable by the processing device to:
navigate the robot by the navigation sensor, wherein:
the robot is navigated around one or more plants in the agricultural field;
the robot is navigated based on a navigation plan corresponding to a predetermined monitoring schedule; and
the navigation plan further corresponds to a predetermined path;
capture a left-side image via the at least one left-facing camera as the robot navigates the agricultural field, the left-side image corresponding to a first plant;
capture a right-side image via the at least one right-facing camera as the robot navigates the agricultural field, the right-side image corresponding to a second plant;
store the left-side image and the right-side image in the memory device; and
output the left-side image and the right-side image to a processing device; and
a server device configured to execute second instructions corresponding to:
a data processing module configured to process the left-side image and the right-side image; and
a display module configured to generate, for display at a user device, the left-side image and the right-side image or the processed data of the left-side image and the right side image, wherein the left-side image and the right-side image are uniquely associated with a location in the agricultural field.

2. A system, comprising:
a plurality of robots, wherein the plurality of robots comprises at least first and second robots, wherein the first robot is configured to navigate an agricultural field, wherein the first robot is configured to traverse a first avenue adjacent to a first crop row, wherein the first robot collects first data along at least a first side of the first crop row; and
wherein the second robot is configured to navigate the agricultural field, wherein the second robot is configured to traverse a second avenue adjacent to a second crop row, wherein the second robot collects second data along at least a second side of the second crop row;
wherein the first and second avenues traversed by the robots are pre-determined, wherein the first and second data are geotagged,
a storage module configured to store the first and second data collected by the first and second robots;
a data processing module configured to process the first and second data collected by the first and second robots; and
a display configured to display at a user device, the processed data generated by the data processing module.

3. The system of claim 2, wherein the first and second data includes one of or any combination of images, sensor measurements, and telemetry.

4. The system of claim 2, wherein the first and second data includes images, wherein the images are used to analyze one of or any combination of the health of the crop row, predict yield, and identify pests.

5. The system of claim 2, further comprising a first charging station, wherein the first robot comprises a first battery, wherein the second robot comprises a second battery, wherein the navigation plan enables one of the first and second robots to charge their respect first and second batteries at the first charging station while the other one of the first and second robots traverse the crops.

6. The system of claim 2, wherein the first robot comprises a first battery and the second robot comprises a second battery, wherein the system comprises one or more charging stations for charging the first and second batteries, wherein the robot with a low level of battery charge navigates to one of the charging stations to charge the battery.

7. The system of claim 2, wherein the first robot includes a first processing device, wherein the first processing device determines a first navigation path for the first robot.

8. The system of claim 2 further comprising a server, wherein the server determines a first navigation path for the first robot, wherein the server determines a second navigation path for the second robot, wherein the first and second navigation paths may be coordinated.

9. The system of claim 2, further comprising a sensor that takes one or more measurements used by the first robot to navigate the agricultural field;
a processing device; and
a memory device storing first instructions executable by the processing device to:
navigate the first robot by the navigation sensor, wherein:
the first robot is navigated around one or more plants in the agricultural field;
the first robot is navigated based on a navigation plan corresponding to a predetermined monitoring schedule; and
the navigation plan further corresponds to a predetermined path.

10. The system of claim 9, wherein the predetermined path is determined at a centralized server, wherein the centralized server has sufficient processing bandwidth to perform multi-factor analysis in determining the predetermined path.

11. The system of claim 10, wherein the centralized server has sufficient processing bandwidth to perform multi-factor analysis in determining an optimal predetermined path for a fleet of robots.

12. The system of claim 10, wherein the centralized server receives information that includes one of or any combination of a farm layout map, terrain information, and specification for the first and second robot.

13. The system of claim 9, wherein each of the first and second robot is programmed to generate a new navigation path when human workers are observed on the current navigation path.

14. The system of claim 2, wherein a first navigation plan is associated with the first robot, and a second navigation plan is associated with the second robot, wherein the first and second navigation plans are planned by dividing rows into subsets that may be navigated in one pass by the first and second robots.

15. The system of claim 2, wherein a first navigation plan is associated with the first robot, and a second navigation plan is associated with the second robot, wherein the first and second navigation plans are planned by dividing rows into subsets that may be navigated in one pass by the first and second robots.

16. The system of claim 2 further comprising:
a camera, wherein the camera is operatively associated with the one of the first and second robots, wherein the camera is configured to capture images as the robot navigates the agriculture field;
a data processing module, wherein the data processing module is configured to process images; and
a display module, wherein the display module is configured to generate, for display at a user device the images captured by the camera.

17. The system of claim 2, wherein the robots are configured to navigate an agricultural field, wherein the number of robots are determined automatically by a processing device based on one or more predetermined factors.

18. The system of claim 2, wherein the one or more predetermined factors include one of or any combination of the size of the farm, the number of crop rows, the length of the crop rows, the slope of the terrain, the variation in the slope of the terrain, a frequency at which the farm is to be surveyed, the speed of the observation robots 106, and the battery capacity of one or more batteries in the one or more robots.

19. The system of claim 2, further comprising a machine learning module

20. The system of claim 19, wherein the machine learning module is configured to perform an inference task, wherein the inference task includes one of or any combination of classification, detection, segmentation, and forecasting on input data and images.
